(19) United States
(12) Patent Application Publication
(10) Pub. No.: US 2011/0216052 A1
(43) Pub. Date: Sep. 8, 2011

(54) SIGNAL LINE DRIVING METHOD FOR DISPLAY APPARATUS, DISPLAY APPARATUS AND SIGNAL LINE DRIVING METHOD

(75) Inventor: Yoshiyuki TANAKA, Kanagawa (JP)

(73) Assignee: RENESAS ELECTRONICS CORPORATION, Kanagawa (JP)

(21) Appl. No.: 12/879,254

(22) Filed: Sep. 10, 2010

(30) Foreign Application Priority Data
Sep. 11, 2009 (JP) 2009-210521

(51) Int. Cl. G09G 5/00

(52) U.S. Cl. 345/209

(57) ABSTRACT

There is provided a driver circuit includes a polarity control unit that decides a polarity preceding by one line from an input polarity signal to generate a data polarity control signal, a data control unit that performs data interchange, at the time of latching the input data, based on the data polarity control signal, and a selector unit that controls the data interchange in an output circuit based on the data polarity control signal.

### TECHNICAL FIELD

### Reference to Related Application

This application is based upon and claims the benefit of the priority of Japanese patent application No. 2009-210521, filed on Sep. 11, 2009, the disclosure of which is incorporated herein in its entirety by reference thereto.

This invention relates to a signal line driver circuit for a display apparatus and to a method for controlling the signal line driver circuit. More particularly, it relates to a signal line driver circuit of a parallel driving system for e.g. a liquid crystal display apparatus, and to a method for controlling the signal line driver circuit.

### BACKGROUND

In these days, in a liquid crystal display apparatus, used for a television receiver or a display for a personal computer, the tendency is towards a larger screen size and a higher resolution. On the other hand, cost reduction is progressing rapidly. The demand for cost reduction of a source driver, used as a signal line driver circuit of a display apparatus, is becoming severer. To cope with this demand, a measure for reducing the size of the source driver per chip is taken because such measure is beneficial from the perspective of reducing the cost for material cost and the numbers of production steps.

FIG. 11 shows a configuration of a source driver 300 of an LCD (Liquid Crystal Display). See FIG. 1 of Patent Document 1. Referring to FIG. 11, the source driver 300 includes a shift register unit 11, a data register 12, a latch unit 13, a decoder 14, a selector unit 17, a positive side reference power supply 15 and a negative side reference power supply 16. The data register 12 and the latch unit 13 have each a storage capacity corresponding to the number of bits of display digital data Dn. The selector unit 17 is composed of a plurality of analog switches. The source driver is controlled by a clock signal CLK, a start signal ST that instructs the start of data latching, and a latch signal LP that instructs the timing for output switching.

The shift register unit 11 starts its operation by a start signal ST supplied once for each display line, that is, once each horizontal period. The shift register transfers the start signal by the clock signal CLK to output a timing signal SP at each shift register stage. The timing signal SP controls the timing of data latching by the data register 12.

The data register 12 sequentially latches the display digital data Dn responsive to the timing signal SP from the shift register unit 11.

After the data is latched by the data register 12, and before the oncoming of data for the next line, the latch unit 13 latches the data in the data register 12 responsive to the latch signal LP.

The decoder 14 decodes the digital data held by the latch unit 13.

The selector unit 17 selects and outputs one of a plurality of gray scale voltages, generated by the positive side reference power supply 15 and the negative side reference power supply 16, based on the decoding result by the decoder 14. The so selected and output gray scale voltages are supplied as driving voltages to respective channels, namely, data lines Q1 to Q240.

The positive side reference power supply 15 directly outputs 16 reference voltages V16 to V31 as 16 gray scale voltages to associated gray scale voltage lines connecting to associated odd channels of the selector unit 17. The negative side reference power supply 16 also directly outputs 16 reference voltages V0 to V15 as 16 gray scale voltages to associated gray scale voltage lines connecting to associated even channels of the selector unit 17. One of the 16 gray scale voltages is selected and output by an associated analog switch in the selector unit 17 based on the decoded result by the decoder 14 (digital signal).

A data input unit 10 and a data output unit 18 possess the data crossing function of interchanging channel data between neighboring channels based on a polarity control signal (data changeover control signal) POL supplied from outside the source driver. It is observed that the data crossing function is the function of switching between a straight connection and a cross connection by a 2-input and 2-output switch. The straight function connects first and second inputs to first and second outputs, respectively, while the cross function connects the first and second inputs to the second and first outputs, respectively.

The signal R/L, supplied to the data input unit 10 and to the shift register unit 11, is a control signal that changes over the data shift direction.

In the driver circuit configuration of FIG. 11, the output polarity of the source driver is determined by the value of the polarity control signal POL sampled by the rising edge of the line head signal STB. The data crossing functions provided in the data input unit 10 and the data output unit 18 are performed by the same polarity control signal POL.

FIG. 12 is a timing chart from the time of data latching by the LCD source driver 300 until its outputting. This drawing has been drafted by the present inventor. In FIG. 12, STB corresponds to ST in FIG. 11. In FIG. 12, S1, S2, S(n−1) and S(n) correspond to the data lines Q1, Q2, Q239, Q240, respectively, if n=240. In FIG. 12, S1, S2, S(n−1) and S(n) also correspond to S1, S2, S(n−1), S(n) of FIG. 1 referred to in the description of the embodiments of the present invention.

In FIG. 12, STH corresponds to the start signal ST of FIG. 11. In FIG. 12, the signal STB is a line leading-end signal that controls the data latching and the output enabling. The interval between neighboring pulses of STB corresponds to a one-line (1H) period. In FIG. 12, OFF and ON of the AMP output correspond to output disabling and output enabling of a driver (amplifier) of the output unit of FIG. 12. The AMP output is turned OFF and ON in a timed relation to the HIGH and LOW periods of STB, respectively.

Referring to FIG. 12, in the case of polarity output inverted on a per line basis (1H inversion driving), the polarity of the signal POL at the time of data latching differs from that at the time of data outputting from the source driver. Hence, with the configuration in which the switching of the data crossing function at the data input unit 10 and that at the output unit 18 are performed of by the same data switching control signal POL, the data crossing control between neighboring channels cannot function correctly.
[Patent Document 1]
JP Patent Kokai Publication No. JP-A-09-114420

### SUMMARY

The entire disclosure of Patent Document 1 is incorporated herein by reference thereto.

The following is an analysis of the related art Publication. In the configuration of FIG. 11, the driver output polarity is determined by the value of the signal POL sampled by the rising edge of the line leading-end signal STB. Hence, the POL polarity at the time of data latching at the directly previous line is not necessarily coincident with the POL polarity at the output line.

In addition, in the configuration of FIG. 11, the data crossing function provided at the data input unit 10 and that provided at the output unit 18 are performed by the same data switching control signal POL. However, as shown in FIG. 12, in the case of the polarity output inverted on a per line basis, the POL polarity at the time of data latching differs from that at the source driver, namely, at the time of outputting at the data output unit 18 of FIG. 11. Thus, in the configuration in which the switching of the data crossing function at the data input unit is carried out with the same data switching control signal POL as that used in the output unit 18, the data crossing control between neighboring channels cannot function correctly.

It is therefore an object of the present invention to provide a signal line driver circuit for a display apparatus, a display apparatus including the same and a signal line driving method, which enables data crossing control to function correctly even in case the polarity at the time of latching data differs from that at the time of data outputting from the signal line driver.

According to the present invention, there is provided a signal line driver circuit for a display apparatus, in which the driver circuit includes:

a polarity control unit that receives a polarity signal and generates, from the polarity signal, a data polarity control signal indicating a polarity preceding by one line;

a data control unit that receives input data and controls an interchange between each of neighboring pairs of the input data, based on the data polarity control signal to output the resulting input data;

a data register unit that captures the input data output from the data control unit;

a data latch unit that latches the data captured in the data register unit on a leading end of a line; and

a selector unit that controls, based on the polarity signal, an interchange between each neighboring pair of output signals, each output signal corresponding to the data from the data latch unit.

In the present invention, the selector unit may be provided between the data latch unit and an output amplifier unit that outputs the output signal on the associated signal line.

According to the present invention, there is provided a method for controlling a signal line driver circuit for a display apparatus, in which the method comprises

deciding a polarity preceding by one line from a polarity signal supplied to the signal line driver circuit; and

in latching input data, controlling to perform an interchange between each neighboring pair of the input data in accordance with the polarity of an output line.

According to the present invention, the data crossing control function correctly even in case the polarity at the time of data latching differs from that at the time of data outputting.

Still other features and advantages of the present invention will become readily apparent to those skilled in this art from the following detailed description in conjunction with the accompanying drawings wherein only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a block diagram showing the configuration of a source driver 100 of a first exemplary embodiment of the present invention.

FIG. 2 is a block diagram showing a circuit configuration of a polarity control unit of the first exemplary embodiment of the present invention.

FIG. 3 is a graph showing an operational waveform of the polarity control unit of the first exemplary embodiment of the present invention.

FIG. 4 is a block diagram showing a circuit configuration of a data control unit 110 of the first exemplary embodiment of the present invention.

FIG. 5 is a graph showing an operational waveform of the data control unit 110 of the first exemplary embodiment of the present invention.

FIG. 6 is a block diagram showing a circuit configuration of a source driver 200 of a second exemplary embodiment of the present invention.

FIG. 7 is a block diagram showing a circuit configuration of a polarity control unit 130 of the second exemplary embodiment of the present invention.

FIG. 8 is a graph showing an operational waveform (for 1H inversion driving) of the polarity control unit 130 of the second exemplary embodiment of the present invention.

FIG. 9 is a graph showing an operational waveform (for 2H inversion driving) of the polarity control unit 130 of the second exemplary embodiment of the present invention.

FIG. 10 is a graph showing an operational waveform (for frame-based polarity inversion) of the polarity control unit 130 of the second exemplary embodiment of the present invention.

FIG. 11 is a block diagram showing a configuration of a source driver 300 of an LCD of a related art.

FIG. 12 is a timing chart as from data latching by a source driver of the related art until data outputting.

### PREFERRED MODES

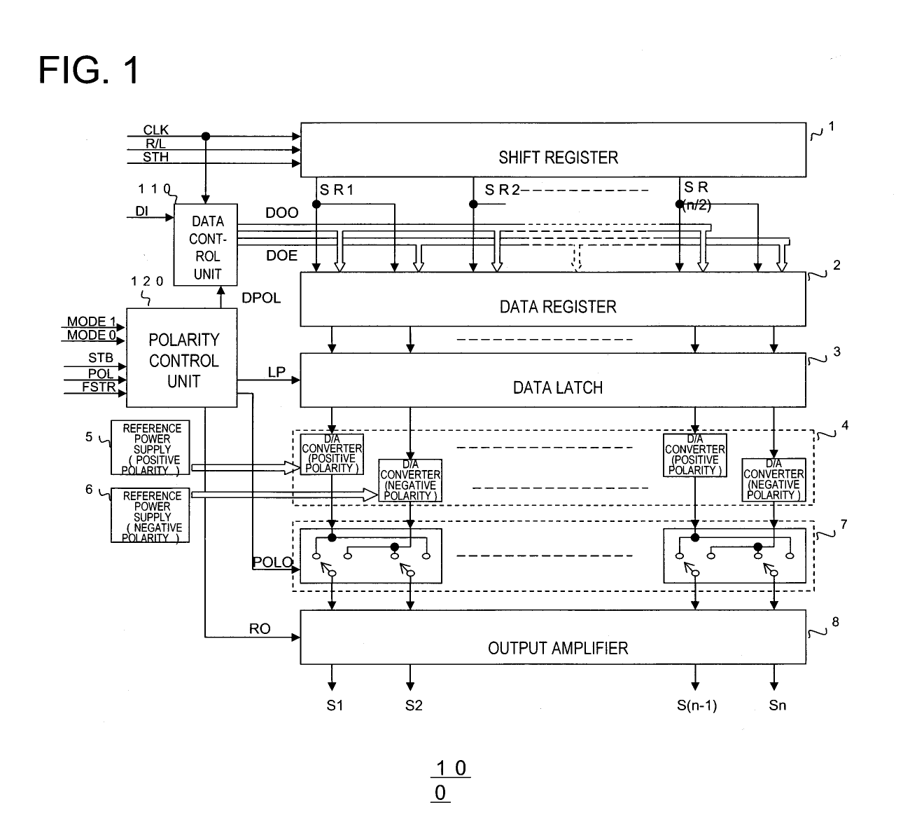

According to the present invention, a selector unit (7 of FIG. 1) that performs a data crossing function is provided between an output of a data register (2 of FIG. 1) on the display data latch side and an input terminal of an output amplifier unit (8 of FIG. 1). The polarity preceding by one line is decided from the polarity signal (POL) inputted to the signal line driver circuit and another polarity signal (DPOL) is generated for controlling the data latching. Data interchanging is carried out in accordance with the polarity of the output line at the time of data latching.

According to the present invention, the data crossing control is exercised using different polarity control signals (DPOL, POLO) for data latch control and for output control of the source driver, respectively. By so doing, the data crossing control between neighboring channels may be managed correctly even in case the polarity at the time of data latching differs from the polarity at the time of data outputting of the source driver.

In one mode of the present invention, a signal line driver circuit of a display apparatus comprises a polarity control unit (120), a data control unit (110) and a selector unit (7). The polarity control unit (120) generates, from an input polarity signal (POL), a data polarity control signal (DPOL) indicating a polarity preceding by one line. The data control unit (110) controls an interchange between a neighboring pair of input data, at the time of capturing the input data (D1), based on the polarity signal. The selector unit (7) controls an interchange between each neighboring pair of output data based on the output polarity control signal (POLO).

In one of preferred mode of the present invention, the data control unit (110) transforms serially inputted neighboring first and second data in parallel and outputs the first or the second data as even data (DOE) and odd data (DOO) or as odd data (DOO) and even data (DOE), respectively, based on a value of the data polarity control signal (DPOL).

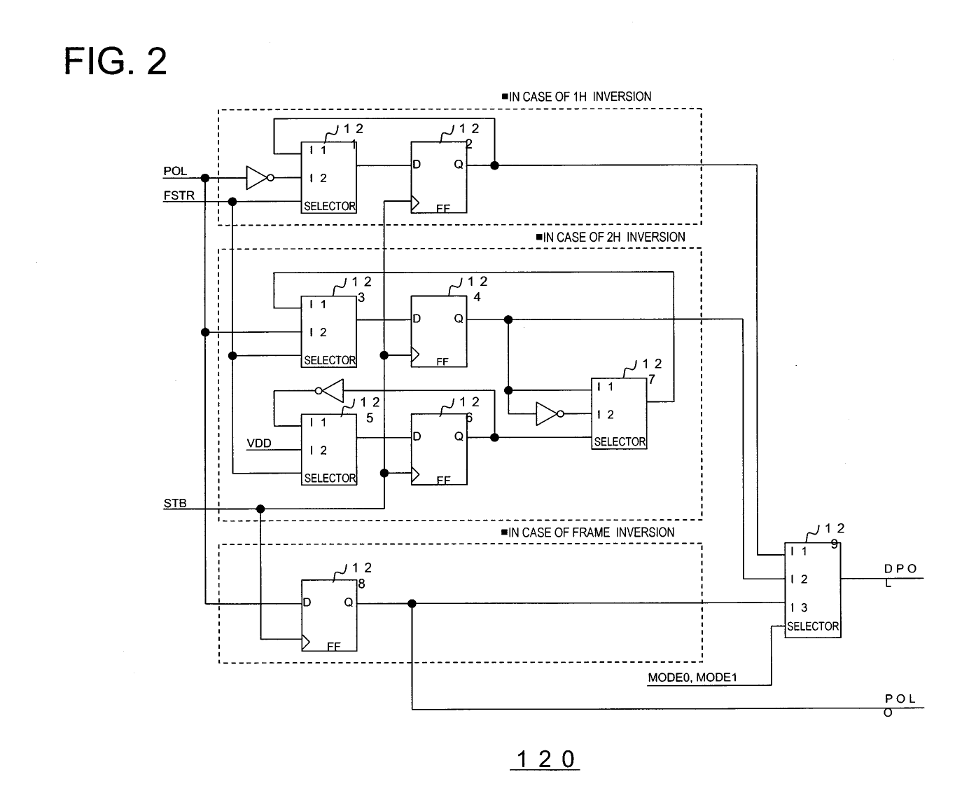

In one of preferred modes of the present invention, the polarity control unit (120) includes a first circuit that generates, for a leading-end signal of a frame, a signal inverted in polarity with respect to the polarity signal. From that time on, the first circuit generates a signal inverted in polarity line by line. The polarity control unit also includes a second circuit that generates, for a leading-end signal of a frame, a signal of the same level as the polarity signal (POL). From that time on, the second circuit generates a second signal which is inverted in polarity at an interval of a plurality of lines. The polarity control unit also includes a third circuit that generates a third signal in phase with the polarity signal, and a selection circuit (129 of FIG. 2). The selection circuit selects and outputs one out of the signals generated by the first, second and third circuits, as the data polarity control signal, depending on whether the current drive is a one-line inversion driving, a multi-line inversion driving or a frame inversion driving, respectively, based on a polarity mode signals (MODE0, MODE1). The present invention will now be described with reference to exemplary embodiments.

### Exemplary Embodiment 1

A first exemplary embodiment of the present invention will now be described. FIG. 1 shows the circuit configuration of a source driver 100 according to the first exemplary embodiment of the present invention. The source driver 100 includes a data control unit 110, a polarity control unit 120, a shift register unit 1, a data register unit 2, a data latch unit 3, a D/A converter unit 4, a reference power supply unit for a positive polarity 5, a reference power supply unit for a negative polarity 6, a selector unit 7 and an output amplifier unit 8.

The polarity control unit 120 receives a polarity control signal POL, a line leading-end signal STB, a frame leading-end signal FSTR and mode signals MODE0 and MODE1, and outputs a source output polarity control signal POLO and a data polarity control signal DPOL to the selector unit 7 and the data control unit 110, respectively. The polarity control unit 120 also outputs a data latch control signal LP and an output amplifier control signal RO to the data latch unit 3 and to the output amplifier unit 8, respectively.

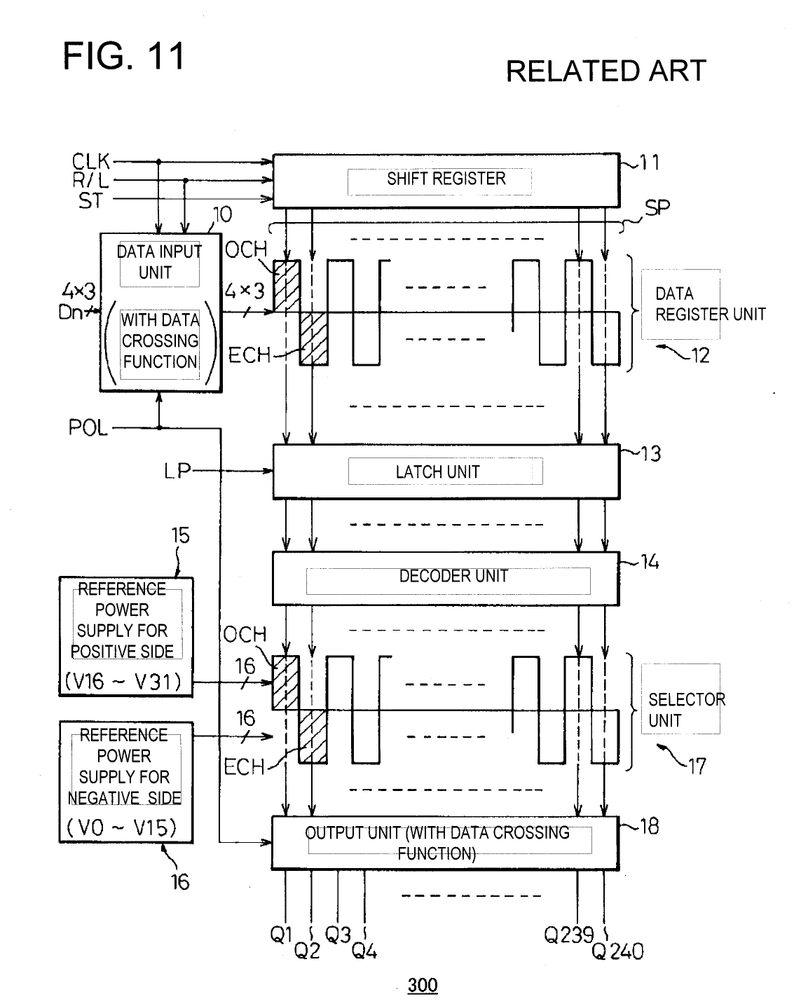

The data control unit 110 interchanges data, based on the data polarity control signal DPOL from the polarity control unit 120, between neighboring channels, for example, between channels 1 and 2, between channels 3 and 4 and so forth. The data control unit 110 includes a data interchanging function of outputting D1 and D2 to the channels 1 and 2, respectively, when the data polarity control signal DPOL is 1, and outputting D2 and D1 to the channels 1 and 2, respectively, when the data polarity control signal DPOL is 0. This data interchanging function corresponds to the data crossing function of FIG. 11.

The shift register unit 1 receives a start signal STH, supplied on a per display line (one horizontal scanning period) and transfers the start signal STH by a clock signal CLK to output timing signals SR1, SR2, . . . , and SR (n/2) from respective corresponding stages of the shift register.

The data register unit 2 includes n number of registers that respectively capture display digital data DOO (odd data) and DOE (even data), sent from the data control unit 110, responsive to the timing signals SR1, SR2, . . . , and SR (n/2) output from the corresponding stages of the shift register unit 1. A set of two neighboring registers that capture DOO (odd data) and DOE (even data) capture DOO (odd data) and DOE (even data), responsive to a common timing signal.

After n items of data are captured by the data register unit 2, the data latch unit 3 latches n items of data in the data register unit 2, all at once, responsive to the data latch control signal LP, at the leading-end of the next display line.

The D/A converter unit 4 includes n number of D/A converters, converting digital data latched by the data latch unit 3, into corresponding analog signals. While n/2 number of D/A converters (positive polarity) select and output, based on respective corresponding signals (digital signals) from the data latch unit 3, respective ones of a plurality of gray scale signals generated by the reference power supply for a positive polarity 5, n/2 number of D/A converters (negative polarity) select and output, based on respective corresponding signals (digital signals) from the data latch unit 3, respective ones of a plurality of gray scale signals generated by the reference power supply unit for a negative polarity 6.

The selector unit 7 includes n/2 number of 2-input and 2-output switches that interchange the gray-scale voltages, selected and output by the D/A converter unit 4, between neighboring ones of the channels, based on the source output polarity control signal POLO. The outputs of the selector unit 7 are supplied, as driving voltages, to output amplifier circuits of the respective channels of the output amplifier unit 8. The outputs of the D/A converter unit of the positive polarity and the D/A converter unit of the negative polarity are supplied to 2-input and 2-output changeover switches. These 2-input and 2-output changeover switches change over the state of connection to a straight connection or to a crossing connection based on the value of the source output polarity control signal POLO.

The output amplifier unit 8 includes n-number of amplifier circuits which are activated in case a control signal (activation control signal) R0 from the polarity control unit 120 is in an activated state. The amplifier circuits output respective voltages corresponding to outputs (gray scale voltages) from the selector unit 7, to source lines S1, S2, . . . , S(n−1), and Sn.

FIG. 2 shows a circuit configuration of the polarity control unit 120. Referring to FIG. 2, the polarity control unit 120 includes a selector 121 and an FF (flip-flop) 122 for 1H inversion driving configuration. The selector 121 receives a feedback signal of an output Q of the FF 122 at its terminal I and an inverted version of POL at its terminal I2. The selector 121 also receives the frame leading-end signal FSTR, as a selection control signal, and selects the terminal I2 or I1 when the frame leading-end signal FSTR is 1 or 0, respectively. The FF 122 samples an output of the selector 121 at a rising edge of the line leading-end signal STB. For a leading-end line of the frame, the FF 122 outputs an inversion level of POL, and subsequently inverts the POL level from one line to the next, that is, at each rising edge of STB.

As a configuration for 2H inversion driving, the polarity control unit 120 includes a selector 123, an FF 124, a selector 125, a FF 126 and a selector 127. The selector 123 receives an output of the selector 127 and POL at its terminals I1 and I2, respectively, and the frame leading-end signal FSTR, as a selection control signal and selects the terminal I2 or I1 when the frame leading-end signal FSTR is 1 or 0, respectively. The FF 124 samples an output of the selector 123 at a rising edge of STB. An output Q of the FF 124 and its inverted signal are supplied to the terminals I1 and I2 of the selector 127. The selector 125 receives an inverted signal of the output Q of the FF 126 and a power supply voltage VDD at its terminals I1 and I2, respectively, and also receives the frame leading-end signal FSTR as a selection control signal. The selector 125 selects the terminal I2 or I1, when the frame leading-end signal FSTR is 1 or 0, respectively. The FF 126 samples an output of the selector 125 by a rising edge of the line leading-end signal STB. An output Q of the FF 125 is supplied to the selector 127 as a selection control signal. The selector 127 selects and outputs the terminal I2 or I1 when the output Q of the FF 125 is 1 or 0, respectively. The selector 127 outputs the same value of DPOL as that of POL at the leading-end line of the frame and, from that time on, outputs a value of DPOL which is inverted every two lines, namely every rising edge of STB.

By way of a configuration for frame inversion driving, the polarity control unit includes an FF 128 that samples POL with the rising edge of the line leading-end signal STB. An output of the FF 128 (POLO) is supplied to the selector unit 7 as a change-over signal.

The selector unit 129 receives outputs of the FF 122, FF 124 and FF 128 at terminals I1, I2 and I3 thereof, respectively, and selects one of the inputs I1, I2 and I3, based on 2-bit signals of MODE0 and MODE1, to output the signal DPOL. Specifically, the selector unit selects I1 when MODE1=0 and MODE0=0, while selecting I2 when MODE1=0 and MODE0=1 and selecting I3 when MODE1=1 (with MODE0=0 or 1). An output of the FF 128 is supplied as the source output polarity control signal POLO.

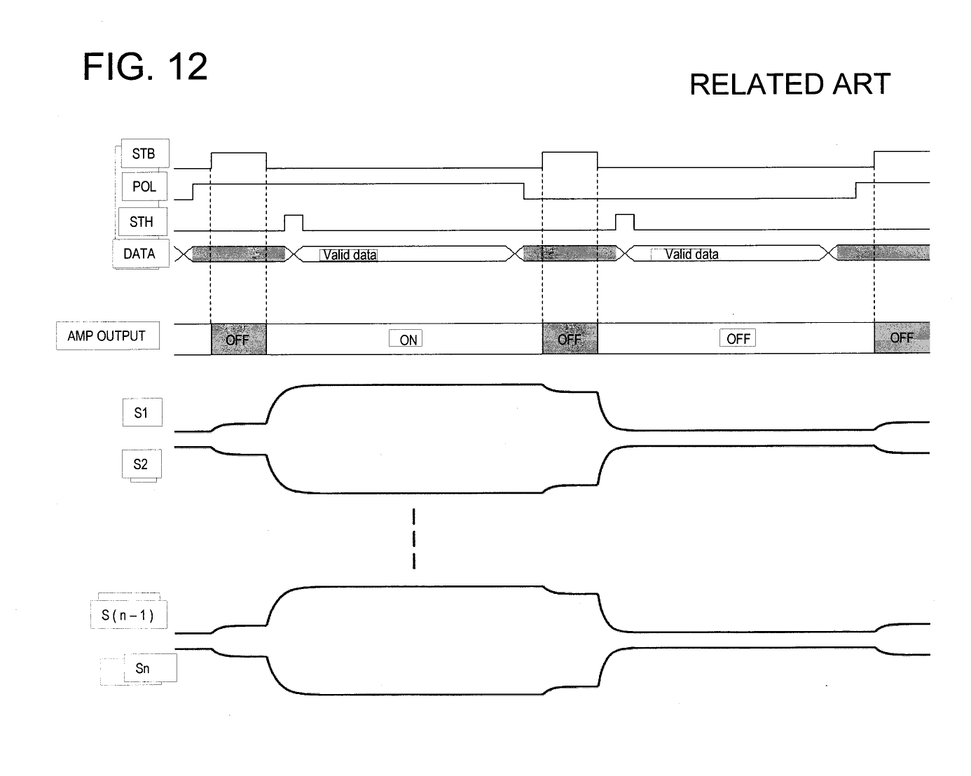

Although not shown in FIG. 2, the polarity control unit 120 may generate the output amplifier control signal RO of FIG. 1 as a complementary signal for STB as shown in FIG. 12. The latch signal LP may be generated based on the line leading-end signal STB.

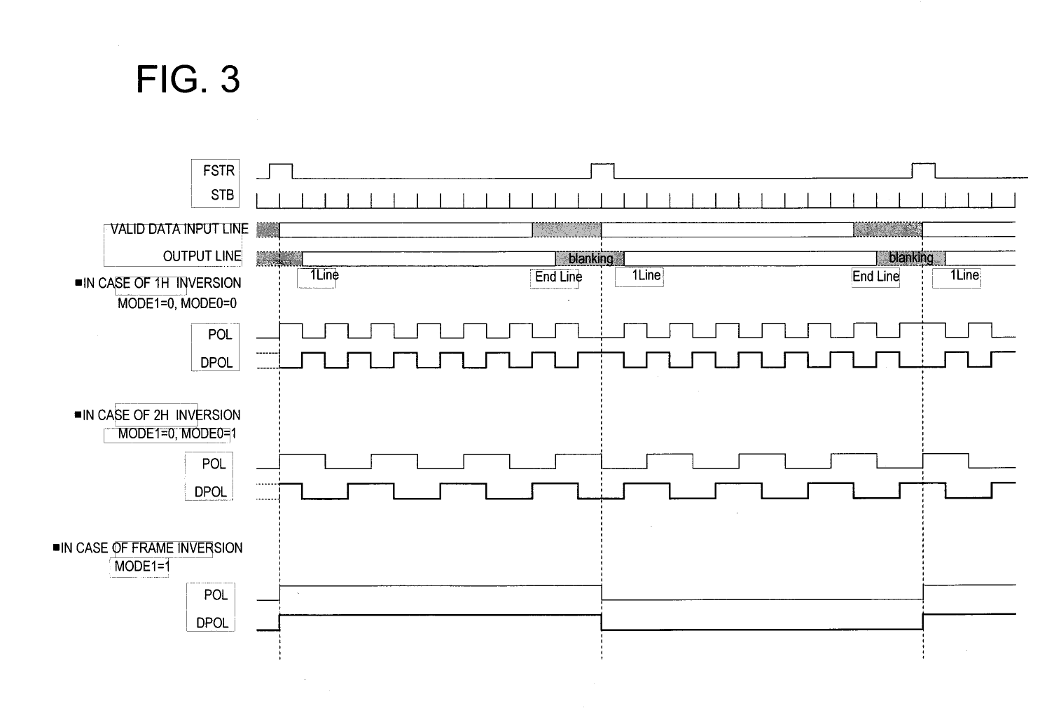

FIG. 3 is a timing chart showing the operation of FIG. 2. FSTR and STB of FIG. 2 are also shown in FIG. 3. In an effective data input line, data input D1 of FIG. 1 is shown. In the output line, data output on each line in a frame and a blanking period are shown. In the 1H inversion driving, POL and DPOL are complementary signals that are inverted in polarity for each STB. In 2H inversion driving, DPOL is of the same value as a one-line of POL at the frame start. After that time, both POL and DPOL are inverted in polarity at the rise time of STB every two lines, and hence are offset relative to each other by one-line equivalent. That is, DPOL entered to the data control unit 110 is shifted by one-line equivalent with respect to POL. In frame-based polarity inversion, POL and DPOL are signals of the same value.

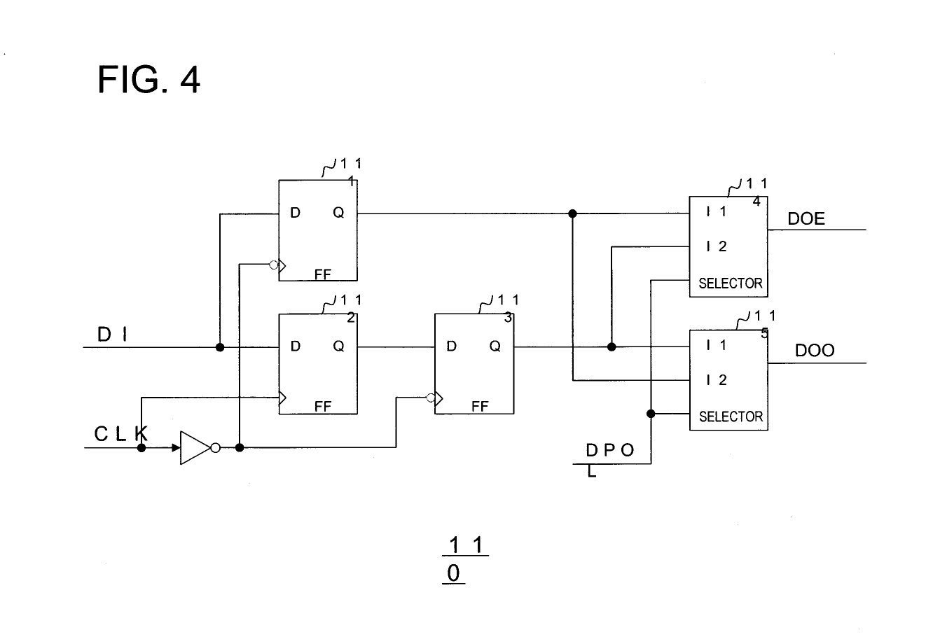

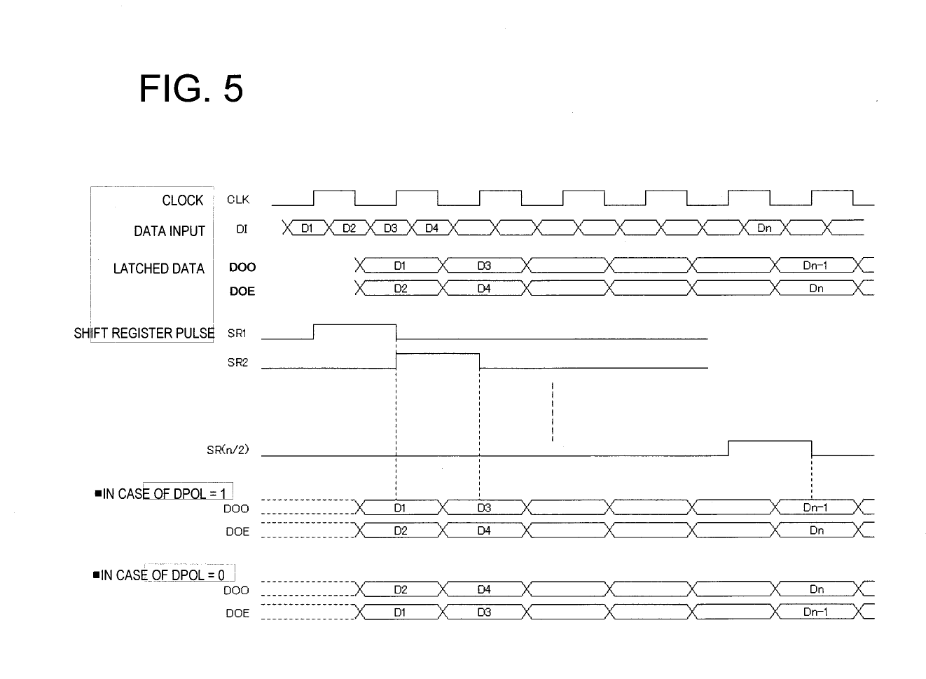

FIG. 4 is a block diagram showing the circuit configuration of the data control unit 110. FIG. 5 is a timing chart showing the operation of FIG. 4. The data control unit 110 includes FFs 111, 112, and 113 and selectors 114 and 115. The FF 111 samples the input data D1 responsive to a falling edge of an inverted version of the clock CLK. The FF 112 samples the input data D1 responsive to a falling edge of an inverted version of the clock CLK, while the FF 113 samples the output of FF 112 responsive to the falling edge of CLK. The selector 114 receives the outputs of the FF 111 and FF 113 at its terminals I1 and I2, respectively, and selects the terminals I1 and I2 when DPOL is 0 and 1, respectively, to output even data DOE as output. The selector 115 receives the outputs of the FF 113 and FF 111 at its terminals I1 and I2, respectively, and selects the terminals I1 and I2 to supply odd data DOO as output when DPOL is 0 and 1, respectively.

FIG. 5 is a timing diagram for illustrating the operation of the circuit of FIG. 4. The clock CLK, data input D1 and outputs DOE and DOO of FIG. 4 are shown. The shift register pulses SR1, SR2 and SR (n/2) are timing signals from the shift register unit 1 of FIG. 1. These are HIGH pulses with a pulse period corresponding to the clock period. The data register unit 2 of FIG. 1 samples DOO and DOE based on the falling edges of the shift register pulses of the associated stages.

If DPOL=1, the selector 114, and 115 select the terminal I2. The selector 114 outputs sampled values (D1, D3, . . . ) of the input data D1 at its terminal DOE at the timing of the rising edge of the clock CLK. The selector 115 outputs sampled values (D2, D4, . . . ) of the input data D1 at its output DOO at the timing of the falling edge of the clock CLK.

If DPOL=0, the selector 114, and 115 select the terminal I1. The selector 114 outputs sampled values (D2, D4, . . . ) of the input data D1 at its output DOE, at the timing of the falling edge of the clock CLK. The selector 115 outputs sampled values (D1, D3, . . . ) of the input data D1 at its output DOO at the timing of the falling edge of the clock CLK.

If, in 1H inversion driving, DPOL=1, in FIG. 1, D1 and D2 are output from the data control unit 110 at DOO and DOE, respectively, and are supplied via the data register unit 2, data latch unit 3 and the D/A converter unit 4 of both the positive and negative polarities to the input terminal of the selector unit 7. Since POLO=0, the selector unit 7 is for straight connection, namely, the output D1 of the D/A converter unit 4 (positive polarity) is output to S1 via the output amplifier unit 8, and the output D2 of the D/A converter unit 4 (negative polarity) is output to S2 via the output amplifier unit 8.

If DPOL=0, D2 and D1 are output from the data control unit 110 at DOO and DOE, respectively, and are supplied via the data register unit 2, data latch unit 3 and the D/A converter unit 4 of both the positive and negative polarities to the input terminal of the selector unit 7. Since POLO=1, the selector unit 7 is for crossing connection, namely, the output D2 of the D/A converter unit 4 (positive polarity) is output to S2 via the output amplifier unit 8 and the output D1 of the D/A converter unit 4 (negative polarity) is output to S1.

The operation of the source driver 100 of the first exemplary embodiment, described above, may be summarized as follows:

(1) The polarity control signal POL, line leading-end signal STB, frame leading-end signal FSTR and the polarity mode changeover signals MODE0, and MODE1 are supplied to the polarity control unit 120.
(2) The input signal POL is latched by FF 128 (FIG. 2) at the rising time of the STB signal. An output of FF 128 is output as the polarity signal POLO synchronized with the leading-end of the line.
(3) The selector outputs the data polarity control signal DPOL, based on set values of MODE0 and MODE1, in accordance with the polarity mode of POL. If the data latch line is to be a reference, it is sufficient that the data polarity control signal DPOL is of the same polarity as that of the output line which is the next following line. The operation of the data polarity control signal DPOL will now be described for each drive mode.

### (A) 1H Inversion

The data polarity control signal DPOL is set at a level of inversion of the signal POL for the frame leading-end line and, from that time on, is inverted in polarity every line.

### (B) 2H Inversion

The data polarity control signal DPOL is set at the same level as the signal POL for the frame leading-end line and, from that time on, is inverted in polarity every two lines.

### (C) Frame Inversion

The data polarity control signal DPOL is in phase with the signal POL (DPOL=POL).

(4) The display input data D1, clock CLK and the data polarity control signal DPOL are supplied to the data control unit 110 (FIG. 4). Based on the data polarity control signal DPOL, the data control unit 110 controls to interchange channel data between neighboring channels. Even pixel data DOE and odd pixel data DOO are thus output to the data register. The selector 114 (FIG. 4) receives currently sampled and the directly previously sampled results of D1, at its terminals I1 and I2, respectively. The selector 114 selects I1 or I2 when the signal DPOL is LOW or HIGH, respectively, and outputs the so selected sampled result as DOE. The selector 115 (FIG. 4) receives D1 currently sampled and the directly previously sampled results of D1 at its terminals 12 and I1, respectively. The selector 115 selects I1 or 12 when the signal DPOL is LOW or HIGH, respectively, and outputs the so selected signal as DOO.
(5) The shift register unit 1 starts its operation by the start signal STH, supplied for each display line (one horizontal period). The shift register performs shift operation by a clock CLK to generate the timing signal SR.
(6) The data register unit 2 sequentially latches the display digital data DOO and DOE, sent from the data control unit 110, responsive to the timing signal SR.
(7) After latching the data by the data register unit 2, the data latch unit 3 latches data in the data register unit 2 in response to the latch signal LP at the leading-end of the next display line.
(8) The D/A converter unit 4 converts the digital data, held by the data latch unit 3, into an analog signal. One of a plurality of gray scale signals which are output from the reference power supply for the positive polarity 5 and the reference power supply for the negative polarity 6, is selected and output.
(9) The selector unit 7 interchanges an analog output on the positive polarity side and an analog output on the negative polarity side, output from the D/A converter unit 4, between the neighboring channels, based on the polarity control signal POL.
(10) The signals supplied to the respective channels (data lines S1 to Sn) as the driving voltages are controlled by the output control signal RO via the output amplifier unit so as to be output via the respective channels.

By deciding, from the polarity mode of the input signal POL, the polarity of the line directly preceding the currently displayed output line, it becomes possible to perform control so that the polarity at the time of latching the display data will be equal to that of the current display line. It is thus possible for the data control unit 110 to interchange data at the time of latching the display data. As a result, it becomes unnecessary to provide a selector unit operative for interchanging the data between the data register unit 2 and the data latch unit 3.

### Exemplary Embodiment 2

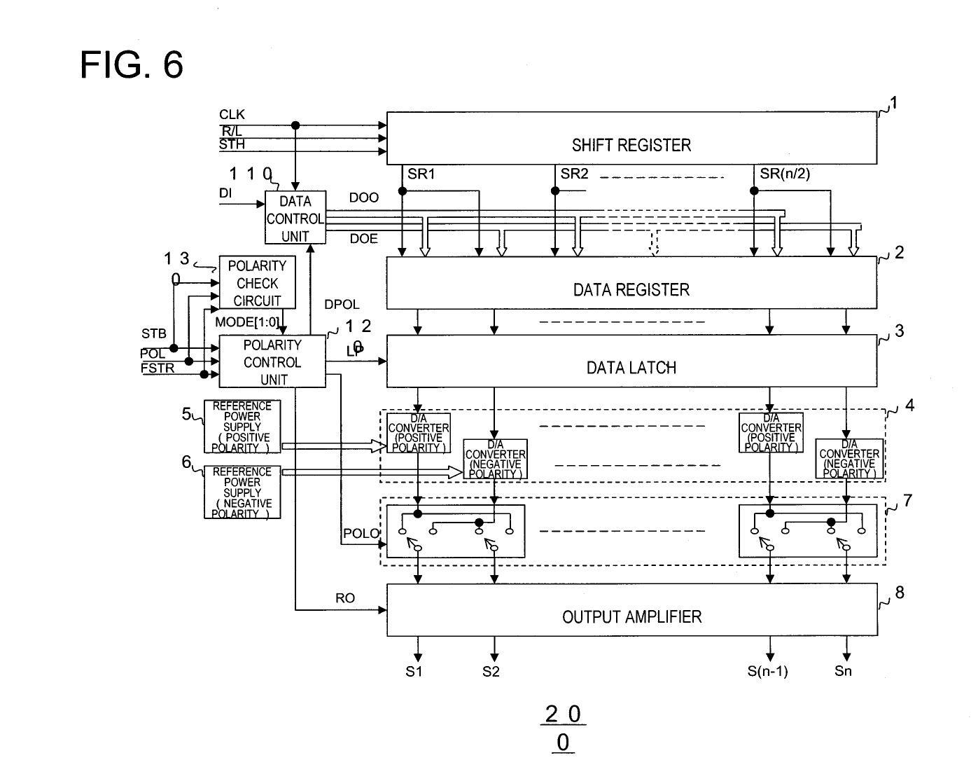

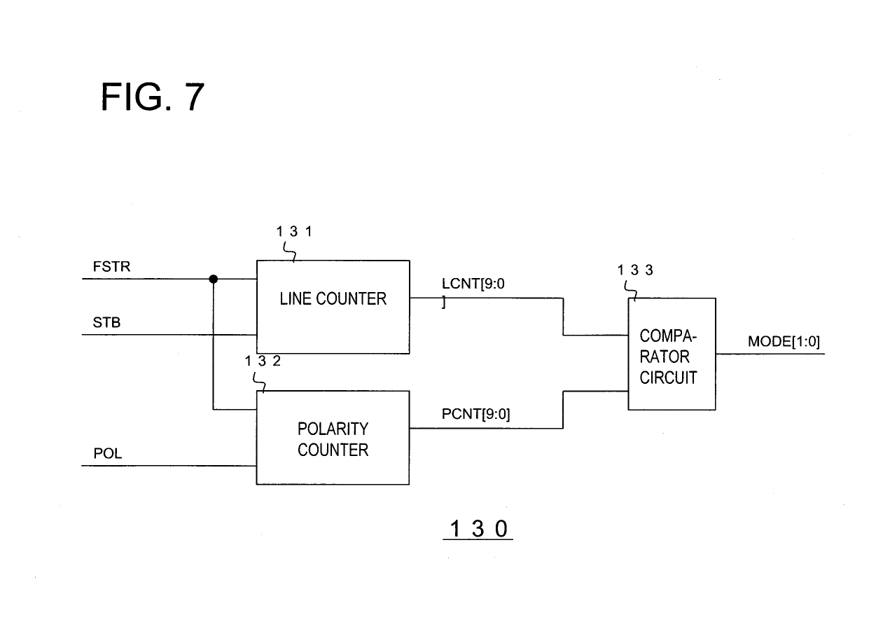

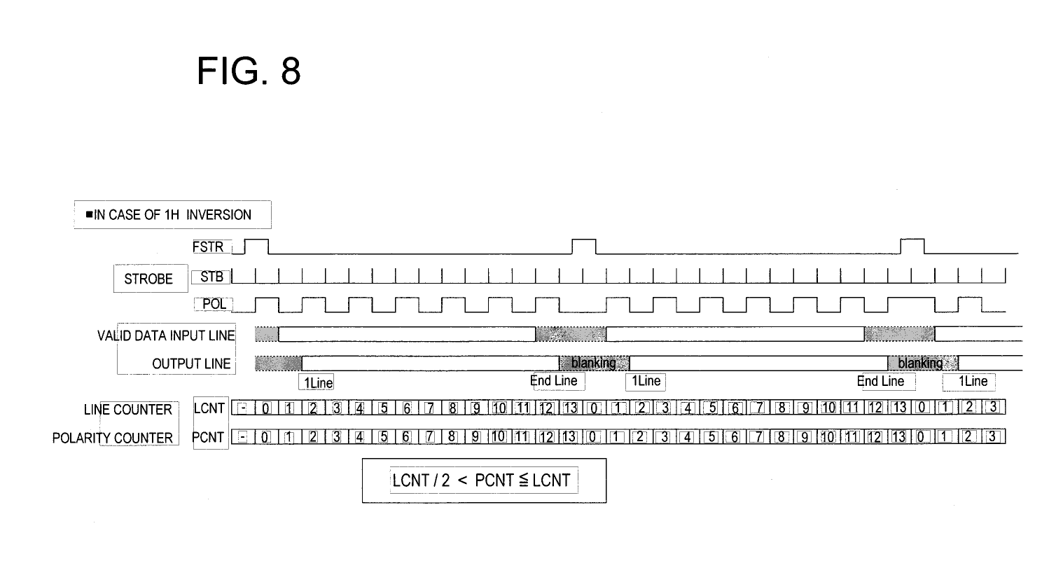

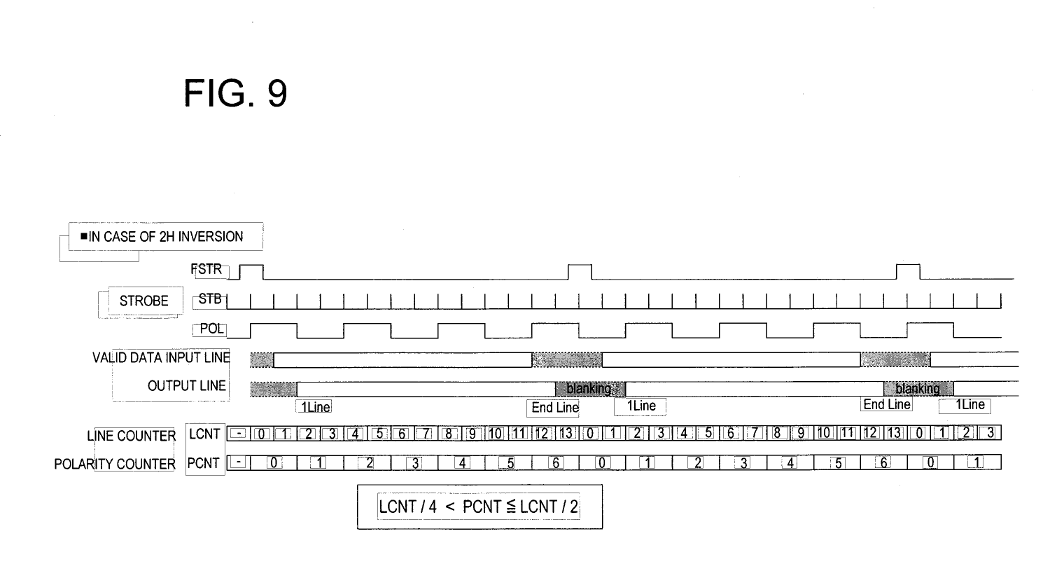

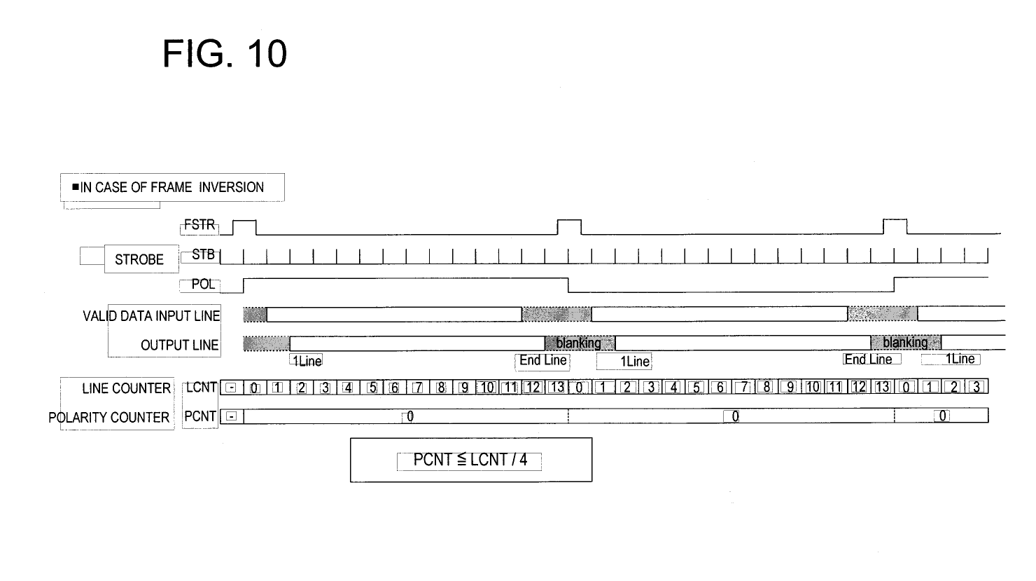

FIG. 6 shows a circuit configuration of a source driver 200 of a second exemplary embodiment of the present invention. The source driver of the second exemplary embodiment includes a polarity decision circuit 130 in addition to the components of the source driver 100 of Example 1. FIG. 7 is a block diagram showing a circuit configuration of the polarity decision circuit 130. The polarity decision circuit 130 includes a line counter 131, a polarity counter 132 and a comparator circuit 133. The line counter 131 receives the frame leading-end signals FSTR and the line leading-end signals STB to perform a count operation thereon. The polarity counter 132 receives the frame leading-end signals FSTR and the polarity signals POL to count the level changes of the signal POL. The comparator circuit 133 compares an output LCNT [9:0] of the line counter 131 and an output PCNT [9:0] of the polarity counter 132. Although the output LCNT [9:0] of the line counter 131 and the output PCNT [9:0] of the polarity counter 132 are 10 bit signals, it goes without saying that the present invention is not to be limited to this configuration. FIG. 8 is a timing chart for illustrating the operation in case of 1H inversion driving in the present exemplary embodiment. FIG. 9 is a timing chart for illustrating the operation in case of 2H inversion driving in the present exemplary embodiment. FIG. 10 is a timing chart for illustrating the operation in case of frame inversion the present exemplary embodiment.

(1) The polarity control signal POL, the line leading-end signal STB and the frame leading-end signal FSTR are supplied to the polarity control unit 120 (FIG. 7).
(2) The line counter 131 counts up, line by line, with the rising of each line leading-end signal STB. The number of lines for a one frame period is counted by initializing the counter when the line leading-end signal STB is active.
(3) The polarity counter 132 counts up for each level change edge of the polarity control signal POL. The change of the level of the POL for one frame period is counted by initializing the counter in case the frame leading-end signal FSTR is active.
(4) The comparator circuit 133 compares the line counter count value LCNT [9:0] and the PCNT [9:0] to decide the polarity mode to output the decision result as the mode changeover signals MODE0 and MODE1. FIG. 8 is a timing diagram showing a typical condition for decision for a 1H inversion, and FIG. 9 is a timing diagram showing a typical condition for decision for a 2H inversion. FIG. 10 is a timing diagram showing a typical condition for decision for a frame inversion.

### (A) 1H Inversion

### LCNT [9:1]/2<PCNT [9:0]<LCNT [9:0]

### (B) 2H Inversion

### LCNT [9:2]/4<PCNT [9:0]<LCNT [9:1]/2

### (C) Frame Inversion

### PCNT [9:0]<LCNT[9:2]/4

(5) The data polarity control signal DPOL is generated in the polarity control unit 120 by the mode changeover signals MODE0 and MODE1 determined by the polarity control unit 120.
(6) The control operations from that time on are the same as those of the first exemplary embodiment described above, and hence the explanation of the operation is dispensed with.

In the first exemplary embodiment, it is necessary to change over the polarity inversion modes with the external input terminals (MODE0, MODE1). In the present exemplary embodiment, mode changeover may automatically be performed by the polarity decision circuit 130.

In the present embodiment, the polarity for the directly preceding line may be decided based on polarity change on an output line. The data crossing control may then be accomplished regularly even in case the polarity at the time of data latching differs from the polarity at the time of data outputting at a source driver. Moreover, the number of components may be reduced, because the selection circuit in the data latch unit 3 is not needed as in FIG. 11. In addition, the configuration of the present invention contributes to reducing the EMI (Electro Magnetic Interference).

The disclosure of the aforementioned Patent Document and the Non-Patent Document is incorporated by reference herein. The particular exemplary embodiments or examples may be modified or adjusted within the gamut of the entire disclosure of the present invention, inclusive of claims, based on the fundamental technical concept of the invention. Further, variegated combinations or selection of elements disclosed herein may be made within the framework of the claims. That is, the present invention may comprehend various modifications or corrections that may occur to those skilled in the art in accordance with and within the gamut of the entire disclosure of the present invention, inclusive of claim and the technical concept of the present invention.

What is claimed is:

1. A signal line driver circuit driving a signal line of a display apparatus, the driver circuit comprising:
a polarity control unit that generates, from a polarity signal supplied thereto, a data polarity control signal indicating a polarity preceding by one line;
a data control unit that controls an interchange between each neighboring pair of the input data received, based on the data polarity control signal to output the resulting input data;
a data register unit that captures the input data output from the data control unit;
a data latch unit that latches the data captured in the data register unit at a leading-end timing of a line;
a selector unit that controls, based on the polarity signal, an interchange between each neighboring pair of output signals, each output signal corresponding to the data from the data latch unit; and
an output amplifier unit that outputs the output signals received from the selector unit to signal lines, respectively.

2. The signal line driver circuit according to claim 1, wherein, in a one-line inversion driving mode, the polarity control unit generates a signal inverted in polarity with respect to the polarity signal for a leading-end line of a frame, as the data polarity control signal, the polarity control unit generating, from that time on, a signal inverted line by line, as the data polarity control signal.

3. The signal line driver circuit according to claim 1, wherein, in a multi-line inversion driving mode, the polarity control unit generates a signal of the same level as that of the polarity signal for a leading-end line of a frame, as the data polarity control signal, the polarity control unit, from that time on, generating a signal inverted in polarity at an interval of a plurality of lines as the data polarity control signal.

4. The signal line driver circuit according to claim 1, wherein, in a frame inversion driving mode, the polarity control unit generates a signal in phase with the polarity signal as the data polarity control signal.

5. The signal line driver circuit according to claim 1, wherein the polarity control unit comprises:
a first circuit that generates, for a leading-end line of a frame, a signal inverted in polarity with respect to the polarity signal, the first circuit generating a signal inverted in polarity line by line from that time on;
a second circuit that generates, for the leading-end line of a frame, a signal of the same level as and inverted in polarity with respect to the polarity signal, the second circuit generating a signal inverted in polarity at an interval of a plurality of lines from that time on;
a third circuit that generates a signal in phase with the polarity signal; and
a selection circuit that selects and outputs one of the signals generated by the first, second and third circuits, as the data polarity control signal, depending on whether a polarity inversion driving mode is one-line inversion driving, multi-line inversion driving or frame inversion driving, based on a polarity mode signal supplied thereto.

6. The signal line driver circuit according to claim 1, wherein the data control unit receives serially the input data and controls to change over between outputting neighboring first and second data serially received, as even and odd data, in parallel, and outputting the neighboring first and second data serially received, as odd and even data, in parallel, depending on the data polarity control signal.

7. The signal line driver circuit according to claim 1, further comprising
a polarity decision circuit that generates a polarity mode signal corresponding to multi-line inversion driving and another polarity mode signal corresponding to frame inversion driving.

8. The signal line driver circuit according to claim 7, wherein the polarity decision circuit includes:
a line counter that counts the number of lines of one frame period;
a polarity counter that counts the number of times of switching of the polarity signal during the one-frame period; and
a comparator circuit that compares an output of the line counter and an output of the polarity counter to generate polarity mode signals corresponding to one-line inversion driving, a multi-line inversion driving or a frame inversion driving.

9. The signal line driver circuit according to claim 1, further comprising:
a shift register unit that receives a start signal supplied thereto on a per line basis, the shift register transferring the start signal, responsive to an input clock signal to generate and output a plurality of timing signals from respective stages thereof;
the data register unit that captures odd-numbered data and even-numbered data, sent from the data control unit, responsive to the timing signal output from an associated stage of the shift register;
the data latch unit that, after data being captured in the data register unit, latches the data in the data register unit, responsive to an input latch signal;
a D/A converter unit including a plurality of D/A converters of positive polarity and a plurality of D/A converters of negative polarity,
each of the D/A converters of positive polarity selecting and outputting one of a plurality of gray scale voltages generated by a reference power supply unit for positive polarity, based on corresponding data latched by the data latch unit,
each of the D/A converters of negative polarity selecting and outputting one of a plurality of gray scale voltages generated by a reference power supply unit for negative polarity, based on the corresponding data latched by the data latch unit;
the selector unit including a plurality of 2-input and 2-output changeover switches, each of the 2-input and 2-output changeover switches receiving, as 2-inputs, the gray scale voltages of positive and negative polarities, selected and output by the associated D/A converter of positive polarity and the associated D/A converter of negative polarity neighboring to one another,
each of the 2-input and 2-output changeover switches changing over between straight connection and crossing connection between neighboring channels, based on a output polarity control signal which the polarity control circuit produces from the polarity signal; and
an output amplifier unit including a plurality of amplifier circuits, each of the amplifier circuits outputting associated output voltages from the 2-input and 2-output changeover switches of the selector unit.

10. A signal line driver circuit driving a signal line of a display apparatus, the driver circuit comprising:
a polarity control unit that receives a polarity signal and generates, from the polarity signal, a data polarity control signal indicating a polarity preceding by one line and an output polarity control signal;
a data control unit that serially receives data and controls to change over between outputting neighboring first and second data serially received, as even and odd data, in parallel, and outputting the neighboring first and second data serially received, as odd and even data, in parallel, depending on the data polarity control signal
a shift register unit that receives a start signal supplied thereto on a per line basis, the shift register transferring the start signal, responsive to an input clock signal to generate and output a plurality of timing signals from respective stages thereof;
a data register unit that captures odd-numbered data and even-numbered data, output from the data control unit, responsive to the timing signal output from an associated stage of the shift register;
a data latch unit that, after data being captured in the data register unit, latches the data in the data register unit, simultaneously, responsive to an input latch, at a leading-end of a next line;
a D/A converter unit including a plurality of D/A converters of positive polarity and a plurality of D/A converters of negative polarity,
each of the D/A converters of positive polarity selecting and outputting one of a plurality of gray scale voltages generated by a reference power supply unit for positive polarity, based on corresponding data latched by the data latch unit,
each of the D/A converters of negative polarity selecting and outputting one of a plurality of gray scale voltages generated by a reference power supply unit for negative polarity, based on the corresponding data latched by the data latch unit;
the selector unit including a plurality of 2-input and 2-output changeover switches, each of the 2-input and 2-output changeover switches receiving, as 2-inputs, the gray scale voltages of positive and negative polarities, selected and output by the associated D/A converter of positive polarity and the associated D/A converter of negative polarity neighboring to one another,
each of the 2-input and 2-output changeover switches changing over between straight connection and crossing connection between neighboring channels, based on the output polarity control signal output from the polarity control unit; and
an output amplifier unit including a plurality of amplifier circuits, each of the amplifier circuits outputting associated output voltages from the 2-input and 2-output changeover switches of the selector unit.

11. The display apparatus including the signal line driver circuit as set forth in claim 1.

12. A method for controlling a signal line driving for a display apparatus, the method comprising:
generating, from an input polarity signal, a data polarity control signal indicating a polarity preceding by one line;
controlling an interchange between each neighboring pair of input data, based on the data polarity control signal;
capturing by a data register unit the input data resulting from the interchange control operation;
latching the data captured in the data register unit at a leading end of a line; and
controlling, based on the polarity signal, an interchange between each neighboring pair of output signals, each output signal corresponding to the data latched.
